(19) United States
(12) Patent Application Publication
(10) Pub. No.: US 2008/0257252 A1
(43) Pub. Date: Oct. 23, 2008

(54) Accident Assistance System for a Motor Vehicle

(75) Inventor: Christian Kobetz, Esslingen (DE)

Correspondence Address: CROWELL & MORING LLP;INTELLECTUAL PROPERTY GROUP, P.O. BOX 14300, WASHINGTON, DC, 20044-4300, US

(73) Assignee: Daimler Chrysler AG, Stuttgart (DE)

(21) Appl. No.: 11/662,453

(22) PCT Filed: Sep. 2, 2005
(86) PCT No.: PCT/EP05/09450

§ 371 Date: Apr. 18, 2008

(30) Foreign Application Priority Data
Sep. 11, 2004 (DE) 10 2004 043 924.9

(51) Int. Cl. B60Q 9/00

(52) U.S. Cl. 116/28 R

(57) ABSTRACT

In an accident assistance system for a motor vehicle having an accident detector for detecting an accident and an assistance device for indicating escape measures and emergency measures in response to the detection of an accidents, instructions which are output by the assistance device are printed on an information carrier which is ejected when an airbag is triggered in the event of an accident. The instructions concerning escape measures and emergency measures are advantageously printed onto the airbag.

This application claims the priority of German patent document 102004043924.9, filed Sep. 11, 2004 (PCT International Application No. PCT/EP2005/009450, filed Sep. 2, 2005, the disclosure of which is expressly incorporated by reference herein.

### BACKGROUND AND SUMMARY OF THE INVENTION

The invention relates to an accident assistance system for a motor vehicle.

After a traffic accident, the parties involved in the accident are in shock and it is not possible to expect carefully considered behavior. In many cases the vehicle occupants leave the vehicle which has been involved in an accident and are hit by another vehicle traveling past. Also, the most basic safety measures are often not implemented in the shocked state because the necessary measures cannot be remembered.

German patent document DE 199 45 147 B4 discloses an accident assistance system of the generic type in which, in the event of an accident, the vehicle occupant is provided with instructions concerning escape measures and emergency measures in response to detection of the state of the damaged vehicle and of the surroundings by sensor. The instructions are issued by voice output and images which are displayed on a screen. The instructions are intended to have a calming effect and comprise a request to put up a warning triangle, a warning about getting out of the vehicle if the vehicle is on a motorway, and addresses for reporting the accident.

German patent document DE 42 36 783 A1 discloses either printing a parts organization information item, such as for example manufacturer's name, product name and test number, directly on the airbag or providing a label which is attached to the airbag and has an optically readable marking (barcode) which is designed to present a parts organization information item.

One object of the present invention is to provide an accident system for a motor vehicle which, in the event of an accident, provides the vehicle occupant with first instructions concerning escape measures and emergency measures, at relatively low cost.

This and other objects and advantages are achieved by the accident assistance system according to the invention, in which the instructions concerning escape measures and emergency measures that are to be output in the event of an accident are printed on an information carrier which is ejected into the passenger compartment of the motor vehicle when an airbag is triggered in an accident. In this way, use is made of the accident sensor system which is already present in the vehicle and decides about the triggering of the airbag.

In one embodiment, the ejection of the information carrier on which instructions are printed is brought about by the explosive unfolding of the airbag. To do this, it is sufficient to arrange the information carrier together with the folded up airbag in the airbag housing so that when the airbag unfolds the information carrier is also ejected. As a result, the vehicle occupant is faced with the information only when he requires it.

In one advantageous development, the information carrier is formed by the airbag itself or a slip which is attached to the airbag. As a result, the instruction with the escape measures and emergency measures moves into the vehicle occupant's field of vision in an appropriate way for the context, when an accident involving triggering of an airbag occurs. The vehicle occupant can read escape measures and emergency measures on the airbag which hangs out after it has unfolded and deflated. The necessary information is thus made available to the person involved in the accident at his location and at the right time.

Since the instructions are directed at the vehicle occupants involved in an accident, it must be possible for a normal sighted person to read the instructions on the information carrier without effort at a distance of 30 to 100 cm and for the representation to have the character of a signal. This is intended to ensure that the information is not overlooked and penetrates the consciousness of the vehicle occupants. In addition to the size of the characters, the color can also increase the character of a signal, such as for example red or green, which are colors known from accident and rescue medical practice.

So that the instructions can be understood independently of language, it is advantageous if the instructions are in the form of pictograms.

The instructions can be provided directly on the airbag by printing in a reflective, fluorescent or phosphorescent color. Alternatively, the instructions can also be provided on the airbag by means of reflective, fluorescent or phosphorescent foil, or by using reflective, fluorescent or phosphorescent fabric or material. With these embodiments an improved signaling effect and visibility at night are achieved.

In one alternative embodiment, the instruction is not provided directly on the airbag but rather on a slip. This slip can be attached to the airbag with one or more tearable seams or detachable adhesive strips. This permits the information carrier to be detached from the airbag so that the person involved in the accident can take the instructions with them when they leave the car or a member of the rescue service can pick up the information. This can be appropriate in order, for example, to have the emergency call number or other safety-related information available. It would also be possible for information about the location of the airbags which are installed in the vehicle to be printed on the information carrier, which is important information for the members of the rescue services who cut up vehicles at certain locations using heavy recovery equipment, so that inadvertent triggering of airbags which have not been fired can be avoided. It would also be possible to store instructions about defined cutting lines on the information carrier, along which the vehicle can be cut up safely (no firing charges) with little effort (no reinforcements of the bodywork of the vehicle).

For a better signaling effect and visibility at night, the slip can be formed from reflective, fluorescent or phosphorescent fabric or foil.

Other objects, advantages and novel features of the present invention will become apparent from the following detailed description of the invention when considered in conjunction with the accompanying drawings.

### BRIEF DESCRIPTION OF THE DRAWINGS

FIG. 1 is a block diagram of the accident assistance system;

FIG. 2 shows an airbag on which the instructions are printed; and

FIG. 3 shows an information carrier with pictograms.

### DETAILED DESCRIPTION OF THE DRAWINGS

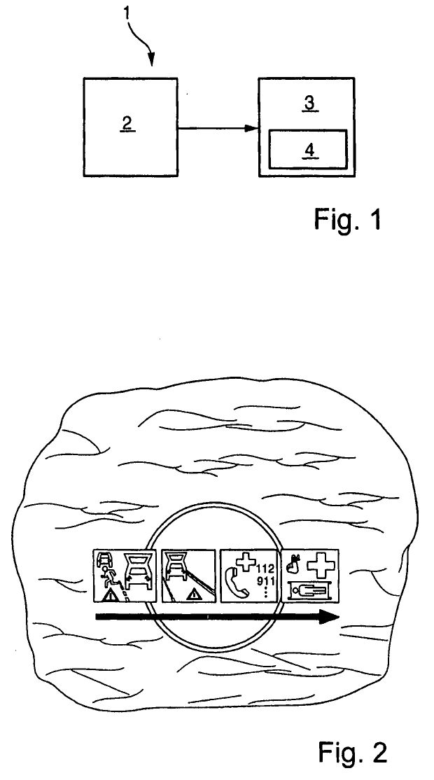

The block diagram in FIG. 1 shows an accident assistance system 1 for a motor vehicle with an accident detector 2 for detecting an accident and an assistance device 3 for indicating escape measures and emergency measures in response to the detection of an accident. The assistance device outputs instructions which are printed on an information carrier 4 which is ejected when an airbag is triggered in the event of accident.

As is shown in FIG. 2, the airbag can advantageously be used as an information carrier. The instructions must be presented in a sufficient size so that they can be clearly recognized and there is a signaling effect. In the exemplary embodiment, the instructions take up approximately ¼ to ⅓ of the area of the airbag which is directed at the vehicle occupant.

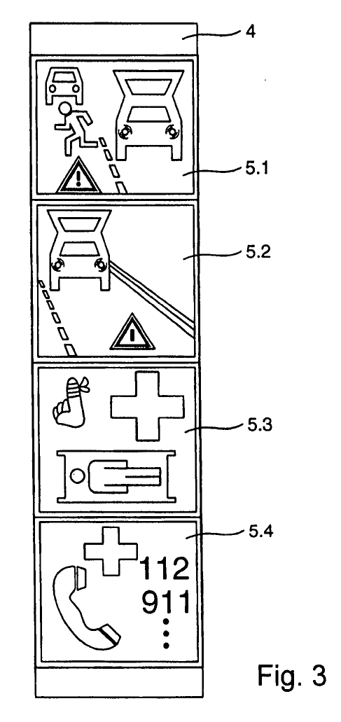

An example of the self-explanatory pictograms on the information carrier 4 is shown in FIG. 3. The first pictogram 5.1 represents a warning against getting out of the vehicle and indicates the danger presented by traffic traveling past. The second pictogram 5.2 indicates that a warning triangle should be put up in order to warn the traffic behind. The third pictogram 5.3 is an instruction that possibly injured persons should be attended to. The fourth pictogram 5.4 indicates that an emergency call should be made.

Of course, the accident assistance system can advantageously be used as a supplement to automatic emergency call systems or more complex emergency assistance systems for car accidents such as that in the aforementioned German patent document DE 199 45 147 B4.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-10. (canceled)

11. An accident assistance system for a motor vehicle, said accident assistance system comprising:
an accident detector for detecting an accident; and
an assistance device for indicating escape measures and emergency measures in response to the detection of an accident; wherein,
the instructions which are output by the assistance device are printed on an information carrier which is ejected into the passenger compartment of the motor vehicle when an airbag is triggered in the event of an accident.

12. The accident assistance system as claimed in claim 11, wherein the information carrier is formed by one of the airbag itself, a slip which is attached to the airbag and a flyleaf.

13. The accident assistance system as claimed in claim 11, wherein:
the instructions on the information carrier can be read without effort by a normal sighted person at a distance of 30 to 100 cm; and
the manner of representation of the instructions has the character of a signal.

14. An airbag for an accident assistance system having an accident detector for detecting an accident; and
an assistance device for indicating escape measures and emergency measures in response to the detection of an accident; wherein,
instructions which are output by the assistance device are printed on an information carrier which is ejected into the passenger compartment of the motor vehicle when an airbag is triggered in the event of an accident, and
the instructions concerning escape measures and emergency measures are provided on the airbag.

15. The airbag as claimed in claim 14, wherein:
the instructions can be read without effort by a normal sighted person at a distance of 30 to 100 cm; and
the manner of representation of the instructions has the character of a signal.

16. The airbag as claimed in claim 15, wherein the instructions printed directly on the airbag, in one of a reflective, fluorescent and phosphorescent color.

17. The airbag as claimed in claim 15, wherein the instructions are provided on the airbag by means of a foil that is one of reflective, fluorescent and phosphorescent.

18. The airbag as claimed in claim 15, wherein the instructions are provided on the airbag by a fabric or material that is one of reflective, fluorescent and phosphorescent.

19. The airbag as claimed in claim 15, wherein the instructions are provided on a slip which is attached to the airbag by at least one tearable seam or by detachable adhesive strips.

20. The airbag as claimed in claim 15, wherein the instructions are provided on a slip that is made of a reflective, fluorescent or phosphorescent fabric or foil.

21. The airbag as claimed in claim 19, wherein the instructions are provided on a slip that is made of a reflective, fluorescent or phosphorescent fabric or foil.
